(19) United States
(12) Patent Application Publication
(10) Pub. No.: US 2018/0014673 A1
(43) Pub. Date: Jan. 18, 2018

(54) Spout for Dispensing Fluids from Containers with Outlets of Varying Diameter

(71) Applicant: Nickolas M Wert, Littleton, CO (US)

(72) Inventor: Nickolas M Wert, Littleton, CO (US)

(21) Appl. No.: 15/653,492

(22) Filed: Jul. 18, 2017

Related U.S. Application Data
(60) Provisional application No. 62/363,476, filed on Jul. 18, 2016.

(51) Int. Cl. A47G 19/22; B65D 47/06; A61J 11/00; B65D 21/02; B65D 47/32; B65D 47/20

(52) U.S. Cl. CPC A47G 19/2272; B65D 47/32; B65D 47/2018; A61J 11/0015; B65D 21/0233; B65D 47/06

(57) ABSTRACT

A spout for dispensing fluids from containers with outlets of varying diameter has a lid, an outlet, a set of nested receptacles, and a set of receptacle-fastening interfaces. The lid is a piece of material used to cover the opening of a container. The outlet is a spout that is connected to the lid and dispenses fluids that are stored within the container to which the lid is affixed. The set of nested receptacles are mounts that work in concert with the set of receptacle-fastening interfaces to affix the lid over the openings of containers of varying shape and size. To accomplish this, the set of nested receptacles extends into the body of the lid; forming mounts that enable the lid to be affixed over the openings of containers.

The current application claims a priority to the U.S. Provisional Patent application Ser. No. 62/363,476 filed on Jul. 18, 2016.

### FIELD OF THE INVENTION

The present invention relates generally to universal lid. In particular, the present invention utilizes a plurality of engagement slots facilitating a screw engagement with openings disposed on beverage containers of varying dimensions.

### BACKGROUND OF THE INVENTION

Traditional sippy cups are manufactured with lids and containers that have been purposefully designed to function as sippy cups. While these devices function as indispensable pieces of spill-prevention gear for parents, they are often bulky. Additionally, traditional sippy cups require a user to employ a container with an opening that was designed to accommodate the sippy cup lid. This restriction decreases the overall versatility of the traditional sippy cup and forces the user to carry around dedicated containers.

The present invention, the spout for dispensing fluids from containers with outlets of varying diameter, addresses this shortcoming by providing a sippy cup lid that can be affixed to containers of varying shape and size. The present invention is able to achieve this functionality by incorporating a plurality of nested receptacles into the sippy cup lid. Each of the plurality of nested receptacles is designed to accommodate the opening of a container that has a desired diameter. The present invention is a universal lid that fits most bottles and threaded containers, and turns them into spill-proof cups These cups avoid leaking spills in cars and on carpets. The different size threads help to ensure that the present invention will fit virtually any bottle. The present invention can come in a wide variety of colors, designs, and even will cut down on dishes.

### BRIEF DESCRIPTION OF THE DRAWINGS

FIG. 1 is an isometric perspective view of the present invention.

FIG. 2 is a right-side view of the present invention.

FIG. 3 is a cross-sectional view of the present invention taken along line 3-3 in FIG. 2; in this view the plurality of receptacle-fastening interfaces is removed for clarity.

FIG. 4 is a cross-sectional view of the present invention taken along line 3-3 in FIG. 2; in this view the plurality of receptacle-fastening interfaces is shown.

FIG. 5 is a bottom view of the present invention.

FIG. 6 is a detailed view of the present invention taken along line 6-6 in FIG. 4; in this view the plurality of receptacle-fastening interfaces is shown.

### DETAIL DESCRIPTIONS OF THE INVENTION

All illustrations of the drawings are for the purpose of describing selected versions of the present invention and are not intended to limit the scope of the present invention.

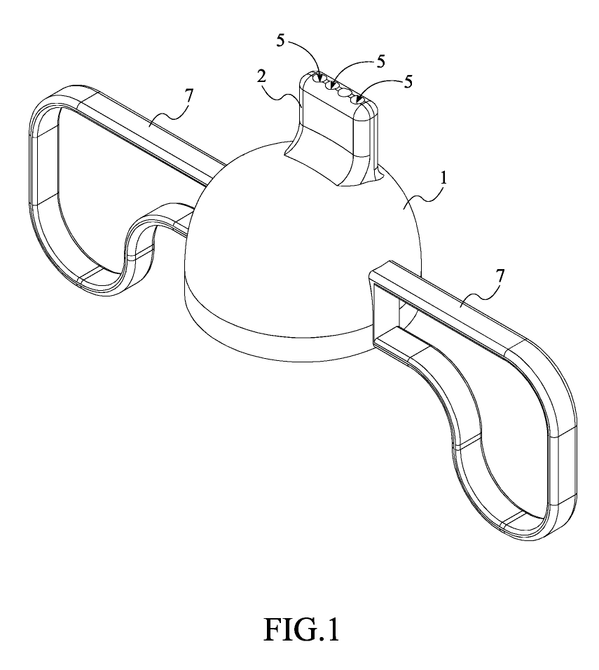

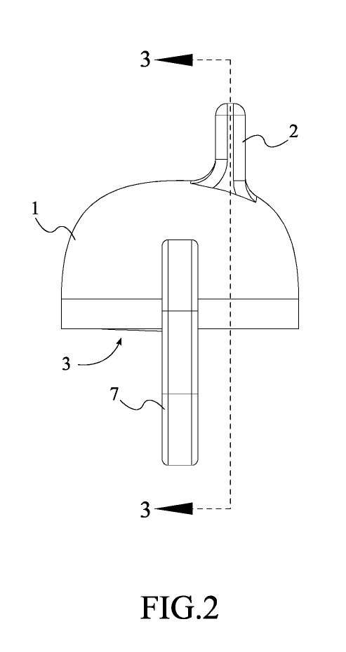

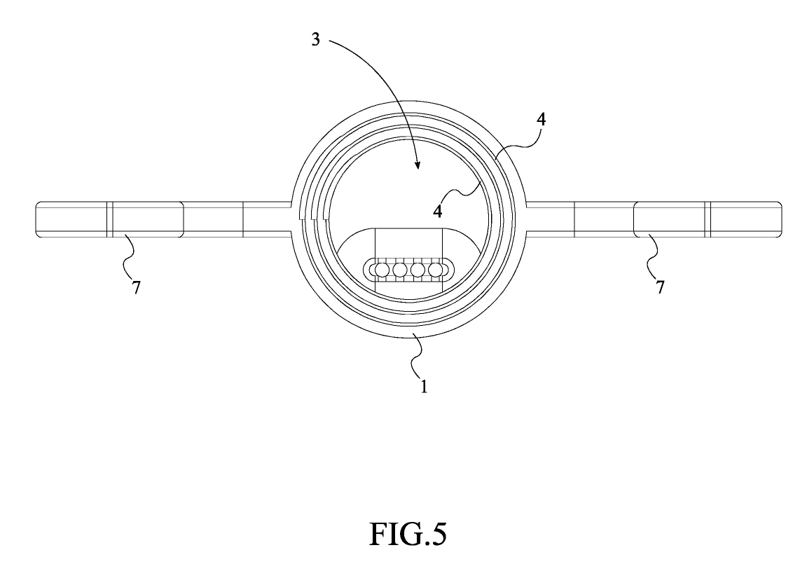

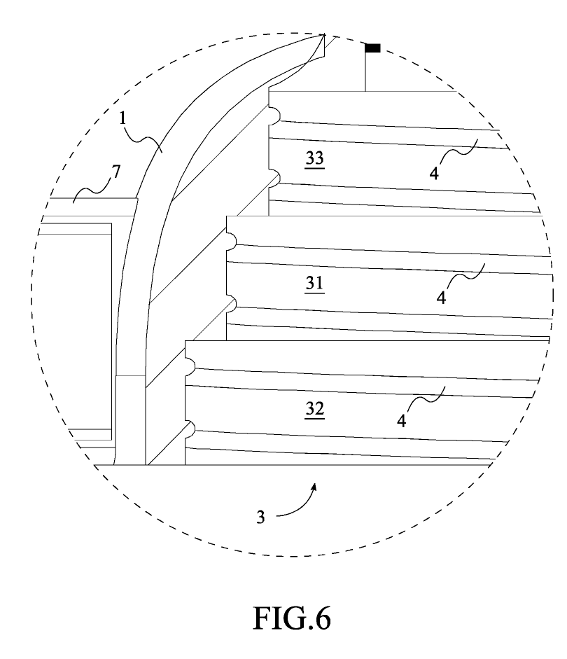

As can be seen in FIG. 1 through FIG. 6, the present invention, the spout for dispensing fluids from containers with outlets of varying diameter, is a device that enables a user to turn fluid containers of varying size into spouted dispensers. To accomplish this, the present invention makes use of a lid that has multiple nested receptacles which are used to fasten the present invention over an opening in a container. The nested receptacles of the present invention are equipped with fastening systems that are able to affix the present invention over container openings. Moreover, the nested receptacles vary in diameter so that the present invention is able to be affixed over the openings of containers with varying shape and size.

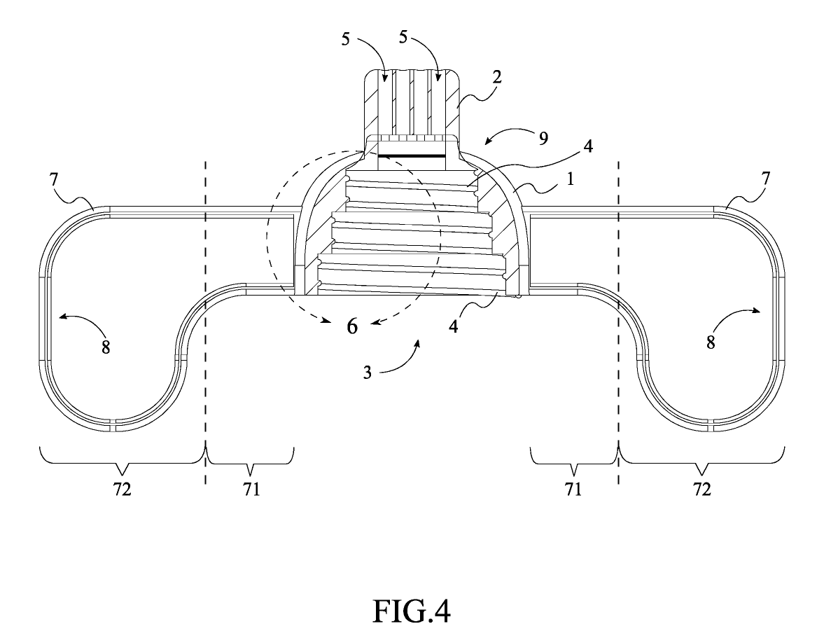

As can be seen in FIG. 1 and FIG. 4, to achieve the above-described functionalities, the present invention comprises a lid 1, an outlet 2, a plurality of nested receptacles 3, and a plurality of receptacle-fastening interfaces 4. The lid 1 is a covering that is placed over the opening of the container to which the present invention is affixed. Additionally, the plurality of nested receptacles 3 is a collection of tiered mounts that are designed to fit around the opening of the container to which the present invention is affixed. As such, fluids stored within the container must pass through the lid 1 while being dispensed. To accomplish this, the outlet 2 is adjacently connected to the lid 1. Furthermore, the plurality of nested receptacles 3 traverses into the lid 1, opposite to the outlet 2. Finally, the plurality of nested receptacles 3 is in fluid communication with the outlet 2. As a result, fluids are only able to be dispensed by passing through the plurality of nested receptacles 3 and out of the outlet 2. The outlet 2 is preferable a spout that is attached to one side of the lid 1 and enables the fluid stored within the container to be dispensed into the user's mouth. Each of the plurality of receptacle-fastening interfaces 4 is internally connected around a corresponding receptacle from the plurality of nested receptacles 3 so that each of the plurality of receptacles can be fastened around the opening of the container to which the present invention is attached. Each of the plurality of receptacle-fastening interfaces 4 is preferably a female threading that is designed to be engaged by a male threading that is positioned around the opening of the container onto which the present invention is affixed.

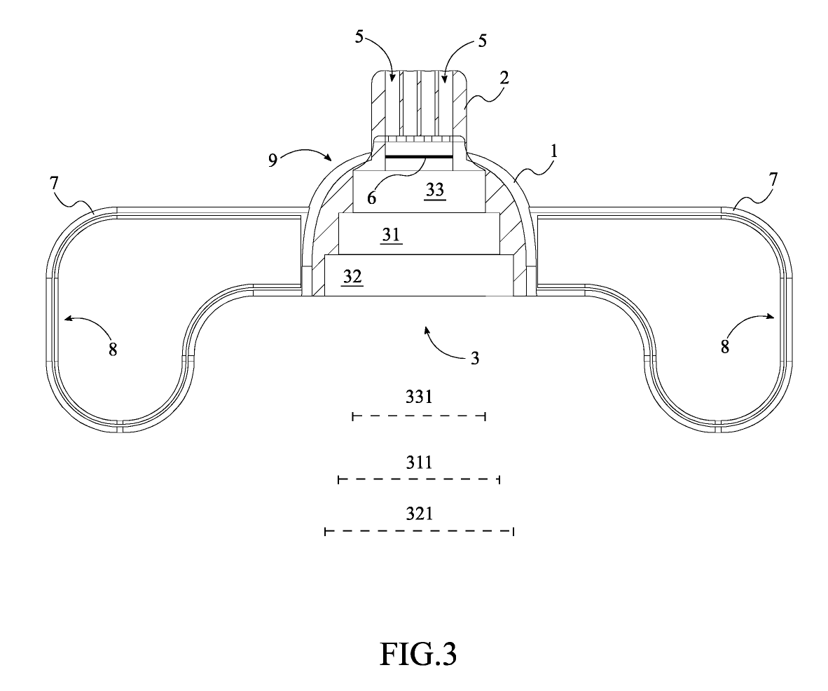

As can be seen in FIG. 1 and FIG. 3, the present invention enables the user to control the flow of fluids being dispensed. To accomplish this, the present invention comprises at least one fluid channel 5. The at least one fluid channel 5 is a channel that passes through the lid 1. Specifically, the at least one fluid channel 5 traverses through the lid 1. Additionally, the plurality of nested receptacles 3 is in fluid communication with the outlet 2 through the at least one fluid channel 5. Consequently, the at least one fluid channel 5 is the supply line that transports fluid from within the plurality of nested receptacles 3 to the outlet 2. The rate of fluid flowing out of the container is controlled by the number of fluid channels 5. In addition to the at least one fluid channel 5, the present invention is able to control the flow of fluid by comprising a user-actuated valve 6. To accomplish this, the user-actuated valve 6 is integrated into the lid 1, in between the plurality of nested receptacles 3 and the outlet 2. Likewise, the plurality of nested receptacles 3 is in fluid communication with the outlet 2 through the user-actuated valve 6. Accordingly, fluid stored within the container is unable to pass through the outlet 2 unless the user opens the user-actuated valve 6. The user-actuated valve 6 is made using various valve types including, but not limited to, one-way valves, diaphragm valves, and pinch valves.

As can be seen in FIG. 3 and FIG. 4, the plurality of nested receptacles 3 can be envisioned as a multitiered frustum that traverses into the side of the lid 1, opposite to the outlet 2. Each tier functions as a receptacle that is used to affix the present invention over the appropriately-sized opening of a container. As such, the plurality of nested receptacles 3 comprises an arbitrary receptacle 31, a preceding receptacle 32, and a subsequent receptacle 33. The arbitrary receptacle 31 is concentrically aligned with the preceding receptacle 32. Similarly, the arbitrary receptacle 31 is concentrically aligned with the subsequent receptacle 33. As a result, the arbitrary receptacle 31, the preceding receptacle 32, and the subsequent receptacle 33 are able to share a similar point of egress for fluids exiting the container. Additionally, a diameter 311 of the arbitrary receptacle 31 is smaller than a diameter 321 of the preceding receptacle 32. Accordingly, the preceding receptacle 32 is able to be affixed around containers with wider openings than the arbitrary receptacle 31. Conversely, a diameter 311 of the arbitrary receptacle 31 is larger than a diameter 331 of the subsequent receptacle 33. Consequently, the arbitrary receptacle 31 is able to be affixed around containers with wider openings than the subsequent receptacle 33.

As can be seen in FIG. 1 and FIG. 4, the present invention is designed to make containers easier to be held in the user's hand. As such, the present invention comprises a plurality of handles 7. The plurality of handles 7 is a collection of ergonomically-shaped handles that enable the user to pick up the present invention. The plurality of handles 7 is adjacently connected to the lid 1. Furthermore, the plurality of handles 7 is peripherally distributed around the lid 1. Thus positioned, each of the plurality of handles 7 is mounted in a location that facilitates grasping and lifting the present invention, as well as any container to which the present invention is affixed. Because the plurality of handles 7 is ergonomically designed, each of the plurality of handles 7 comprises an extension portion 71 and an elongated hand-receiving portion 72. The extension portion 71 is an assembly that connects each of the plurality of handles 7 to the lid 1. Specifically, the lid 1 is terminally connected to the extension portion 71. The elongated hand-receiving portion 72 is the section of the handle that is grasped by the user. Likewise, the elongated hand-receiving portion 72 is terminally connected to the extension portion 71, opposite to the lid 1. Additionally, the elongated hand-receiving portion 72 is positioned perpendicular to the extension portion 71. As a result, the elongated hand-receiving portion 72 is positioned to facilitate grasping and moving the present invention.

As can be seen in FIG. 1 and FIG. 4, the present invention is designed to prevent the spread of microorganisms, even after extended use. To accomplish this, the present invention comprises a first antimicrobial coating 8, and a second antimicrobial coating 9. The first antimicrobial coating 8 and the second antimicrobial coating 9 are designed to inhibit the growth of pathogenic microorganisms. As such, the first antimicrobial coating 8 is superimposed onto each of the plurality of handles 7. Similarly, the second antimicrobial layer is superimposed onto the lid 1, the outlet 2, the plurality of nested receptacles 3, and the plurality of receptacle-fastening interfaces 4. Thus positioned, the first antimicrobial coating 8 and the second antimicrobial coating 9 create a covering that inhibits the growth of bacteria on the present invention.

Although the invention has been explained in relation to its preferred embodiment, it is to be understood that many other possible modifications and variations can be made without departing from the spirit and scope of the invention as hereinafter claimed.

What is claimed is:

1. A spout for dispensing fluids from containers with outlets of varying diameter comprises:
a lid;
an outlet;
a plurality of nested receptacles;
a plurality of receptacle-fastening interfaces;
the outlet being adjacently connected to the lid;
the plurality of nested receptacles traversing into the lid, opposite to the outlet;
the plurality of nested receptacles being in fluid communication with the outlet; and
each of the receptacle-fastening interfaces being internally connected around a corresponding receptacle from the plurality of nested receptacles.

2. The spout for dispensing fluids from containers with outlets of varying diameter as claimed in claim 1 comprises:
at least one fluid channel;
the at least one fluid channel traversing through the lid; and
the plurality of nested receptacles being in fluid communication with the outlet through the at least one fluid channel.

3. The spout for dispensing fluids from containers with outlets of varying diameter as claimed in claim 1 comprises:
a user-actuated valve;
the user-actuated valve being integrated into the lid, in between the plurality of nested receptacles and the outlet; and
the plurality of nested receptacles being in fluid communication with the outlet through the user-actuated valve.

4. The spout for dispensing fluids from containers with outlets of varying diameter as claimed in claim 1, wherein each of the plurality of receptacle-fastening interfaces is a female threading.

5. The spout for dispensing fluids from containers with outlets of varying diameter as claimed in claim 1 comprises:
the plurality of nested receptacles comprises an arbitrary receptacle and a preceding receptacle;
the arbitrary receptacle being concentrically aligned with the preceding receptacle; and
a diameter of the arbitrary receptacle being smaller than a diameter of the preceding receptacle.

6. The spout for dispensing fluids from containers with outlets of varying diameter as claimed in claim 1 comprises:
the plurality of nested receptacles comprises an arbitrary receptacle and a subsequent receptacle;
the arbitrary receptacle being concentrically aligned with the subsequent receptacle; and
a diameter of the arbitrary receptacle being larger than a diameter of the subsequent receptacle.

7. The spout for dispensing fluids from containers with outlets of varying diameter as claimed in claim 1 comprises:
a plurality of handles;
the plurality of handles being adjacently connected to the lid; and
the plurality of handles being peripherally distributed around the lid.

8. The spout for dispensing fluids from containers with outlets of varying diameter as claimed in claim 7 comprises:
each of the plurality of handles comprises an extension portion and an elongated hand-receiving portion;
the lid being terminally connected to the extension portion;
the elongated hand-receiving portion being terminally connected to the extension portion, opposite to the lid; and
the elongated hand-receiving portion being positioned perpendicular to the extension portion.

9. The spout for dispensing fluids from containers with outlets of varying diameter as claimed in claim 7 comprises:
a first antimicrobial coating; and
the first antimicrobial coating being superimposed onto each of the plurality of handles.

10. The spout for dispensing fluids from containers with outlets of varying diameter as claimed in claim 1 comprises:
a second antimicrobial coating; and
the second antimicrobial layer being superimposed onto the lid, the outlet, the plurality of nested receptacles, and the plurality of receptacle-fastening interfaces.

11. A spout for dispensing fluids from containers with outlets of varying diameter comprises:
a lid;
an outlet;
a plurality of nested receptacles;
a plurality of receptacle-fastening interfaces;
at least one fluid channel;
a user-actuated valve;
the plurality of nested receptacles comprises an arbitrary receptacle, a preceding receptacle, and a subsequent receptacle;
a plurality of handles;
the outlet being adjacently connected to the lid;
the plurality of nested receptacles traversing into the lid, opposite to the outlet;
the plurality of nested receptacles being in fluid communication with the outlet;
each of the receptacle-fastening interfaces being internally connected around a corresponding receptacle from the plurality of nested receptacles;
the at least one fluid channel traversing through the lid;
the plurality of nested receptacles being in fluid communication with the outlet through the at least one fluid channel;
the user-actuated valve being integrated into the lid, in between the plurality of nested receptacles and the outlet;
the plurality of nested receptacles being in fluid communication with the outlet through the user-actuated valve;
the arbitrary receptacle being concentrically aligned with the preceding receptacle;
a diameter of the arbitrary receptacle being smaller than a diameter of the preceding receptacle;
the arbitrary receptacle being concentrically aligned with the subsequent receptacle;
a diameter of the arbitrary receptacle being larger than a diameter of the subsequent receptacle;
the plurality of handles being adjacently connected to the lid; and
the plurality of handles being peripherally distributed around the lid.

12. The spout for dispensing fluids from containers with outlets of varying diameter as claimed in claim 11, wherein each of the plurality of receptacle-fastening interfaces is a female threading.

13. The spout for dispensing fluids from containers with outlets of varying diameter as claimed in claim 11 comprises:
each of the plurality of handles comprises an extension portion and an elongated hand-receiving portion;
the lid being terminally connected to the extension portion;
the elongated hand-receiving portion being terminally connected to the extension portion, opposite to the lid; and
the elongated hand-receiving portion being positioned perpendicular to the extension portion.

14. The spout for dispensing fluids from containers with outlets of varying diameter as claimed in claim 11 comprises:
a first antimicrobial coating; and
the first antimicrobial coating being superimposed onto each of the plurality of handles.

15. The spout for dispensing fluids from containers with outlets of varying diameter as claimed in claim 11 comprises:
a second antimicrobial coating; and
the second antimicrobial layer being superimposed onto the lid, the outlet, the plurality of nested receptacles, and the plurality of receptacle-fastening interfaces.

16. A spout for dispensing fluids from containers with outlets of varying diameter comprises:
a lid;
an outlet;
a plurality of nested receptacles;
a plurality of receptacle-fastening interfaces;
at least one fluid channel;
a user-actuated valve;
the plurality of nested receptacles comprises an arbitrary receptacle, a preceding receptacle, and a subsequent receptacle;
a plurality of handles;
a first antimicrobial coating;
a second antimicrobial coating;
the outlet being adjacently connected to the lid;
the plurality of nested receptacles traversing into the lid, opposite to the outlet;
the plurality of nested receptacles being in fluid communication with the outlet;
each of the receptacle-fastening interfaces being internally connected around a corresponding receptacle from the plurality of nested receptacles;
the at least one fluid channel traversing through the lid;
the plurality of nested receptacles being in fluid communication with the outlet through the at least one fluid channel;
the user-actuated valve being integrated into the lid, in between the plurality of nested receptacles and the outlet;
the plurality of nested receptacles being in fluid communication with the outlet through the user-actuated valve;
the arbitrary receptacle being concentrically aligned with the preceding receptacle;
a diameter of the arbitrary receptacle being smaller than a diameter of the preceding receptacle;
the arbitrary receptacle being concentrically aligned with the subsequent receptacle;
a diameter of the arbitrary receptacle being larger than a diameter of the subsequent receptacle;
the plurality of handles being adjacently connected to the lid;
the plurality of handles being peripherally distributed around the lid;
the first antimicrobial coating being superimposed onto each of the plurality of handles; and
the second antimicrobial layer being superimposed onto the lid, the outlet, the plurality of nested receptacles, and the plurality of receptacle-fastening interfaces.

17. The spout for dispensing fluids from containers with outlets of varying diameter as claimed in claim 16, wherein each of the plurality of receptacle-fastening interfaces is a female threading.

18. The spout for dispensing fluids from containers with outlets of varying diameter as claimed in claim 16 comprises:
each of the plurality of handles comprises an extension portion and an elongated hand-receiving portion;
the lid being terminally connected to the extension portion;
the elongated hand-receiving portion being terminally connected to the extension portion, opposite to the lid; and
the elongated hand-receiving portion being positioned perpendicular to the extension portion.
